(19) United States
(12) Patent Application Publication
(10) Pub. No.: US 2002/0140387 A1
(43) Pub. Date: Oct. 3, 2002

(54) Method and apparatus for preparing for car wash

(76) Inventor: Anthony L. Gorsick, Lake Orion, MI (US)

Correspondence Address: Mark P. Calcaterra, DaimlerChrysler Intellectual Capital Corporation, CIMS 483-02-19, 800 Chrysler Drive, Auburn Hills, MI, 48326-2757, US

(21) Appl. No.: 09/818,421

(22) Filed: Mar. 27, 2001

(51) Int. Cl. H02P 1/00; H02P 3/00; G05B 5/00; H02P 7/00; H02H 7/08

(52) U.S. Cl. 318/445

(57) ABSTRACT

A car-wash ready system is described in combination with a vehicle having a plurality of parts operable between at least a first state in which the part is not ready for an automated car wash, and a second state in which the part is ready for an automated car wash. The car-wash ready system includes at least one processor having a car-wash ready mode in which the processor is configured for operating the parts to their second car-wash-ready states, and a switch for switching the processor into and out of its car-wash ready mode. This system provides a convenient way for a vehicle driver to prepare the vehicle for a car wash. Additionally, by temporarily locking certain parts from operation, the system prevents the driver from inadvertently exposing the vehicle to damage while the vehicle is going through the car wash.

### FIELD OF THE INVENTION

The present invention relates generally to motor vehicles and, more particularly, to preparing a motor vehicle for a car wash

### BACKGROUND OF THE INVENTION

Preparing a vehicle for an automated car wash requires that a number of steps be taken to prevent damage to the vehicle. It is known for motor vehicles to have automatic windshield wipers that can be activated by a rain sensor located on or near the vehicle windshield. For example, U.S. Pat. No. 6,121,741 issued to Berger et al. describes a control device for operating a window wiper at a frequency dependent on a predetermined wetting degree of the window. Although such wipers are convenient under natural precipitation conditions, activation of a rain sensor and wipers by water in a car wash can result in damage to the wipers from car washing equipment. Similarly, operating a vehicle radio while the vehicle is going through a car wash can activate extension of a power antenna, thus exposing the antenna to possible damage. Of course, preparing a vehicle for going through a car wash also entails having to close a sun roof and any side and rear windows that may be open. It may also be advisable to fold in side-mounted mirrors of the vehicle.

It would be desirable to provide a system that automatically performs the plurality of tasks involved preparing a vehicle for a car wash. It also would be desirable to provide a way of ensuring, that as a vehicle goes through the car wash, the driver does not inadvertently take an action (such as turning on a radio) that might expose the vehicle part to damage.

### SUMMARY OF THE INVENTION

The present invention in one embodiment is a car-wash ready system, in combination with a vehicle having a plurality of parts operable between at least a first state in which the part is not ready for an automated car wash, and a second state in which the part is ready for an automated car wash. The car-wash ready system includes at least one processor having a car-wash ready mode in which the processor is configured for operating the parts to their second car-wash-ready states, and a switch for switching the processor into and out of its car-wash ready mode.

The foregoing system provides a convenient way for a vehicle driver to prepare the vehicle for a car wash. Additionally, by temporarily locking certain parts from operation, the system prevents the driver from inadvertently exposing the vehicle to damage while the vehicle is going through the car wash.

Additional benefits and advantages of the present invention will become apparent to those skilled in the art to which this invention relates from a reading of the subsequent description of the preferred embodiment and the appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a schematic illustration of a system for preparing a vehicle for a car wash.

FIG. 2 is a flow diagram of a method for preparing a vehicle for a car wash.

### DETAILED DESCRIPTION OF THE PREFERRED EMBODIMENTS

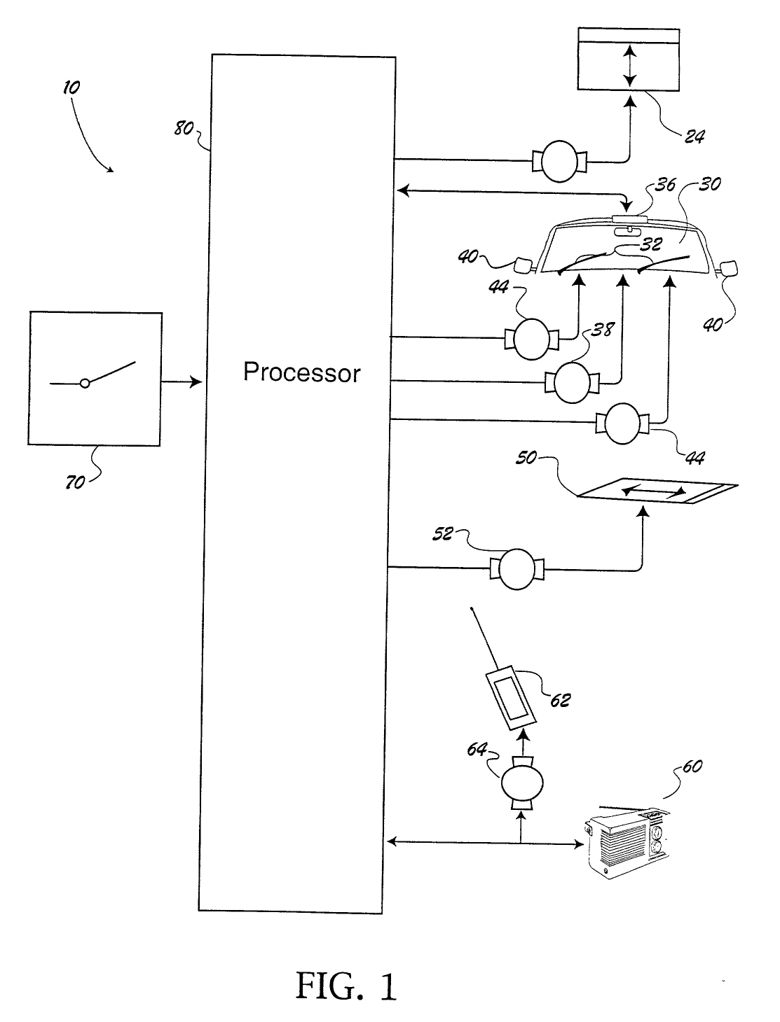

FIG. 1 illustrates one embodiment of a system 10 for preparing a vehicle (parts of which are shown in FIG. 1) for a car wash. As shown and described in the preferred embodiment, the vehicle includes at least one window 24 operated by at least one motor 26. As shown and described in this preferred embodiment, the vehicle also includes at least one windshield or window 30 having one or more wipers 32. These wipers are preferably of the type that are automatically activated when a rain sensor 36 senses moisture. The wipers 32 are operated by a motor 38. As shown and described in this preferred embodiment, the vehicle also includes side-mounted folding mirrors 40 operated by motors 44 and adjustable by an operator or driver (not shown) of the vehicle. As shown and described in this preferred embodiment, this vehicle also includes a sun roof 50 operated by a motor 52. Finally and as shown and described in this preferred embodiment, the vehicle also includes a radio 60 and a power antenna 62 operated by a motor 64. The vehicle may include additional or different parts not shown herein but contemplated to be prepared by system 10 for going through a car wash.

System 10 includes a switch 70 and a processor 80. (The terms “processor” and “controller” are used interchangeably herein and include, but are not limited to, computers, controllers, microcomputers, microcontrollers, processors, microprocessors and the like.) In another embodiment the switch 70 includes a button (not shown) that is pressed by the driver to activate system 10, for example, just prior to entering a car wash. In still another embodiment, the switch 70 is controlled via a programmable controller (not shown) in connection with an electronic vehicle information center (EVIC). In one embodiment the programmable controller includes the processor 80. When the switch 70 is activated, an indicator (not shown) such as a chime, EVIC or cluster light is activated to show that system 10 is activated, and the processor 80 is switched into a car-wash-ready mode.

More specifically, the processor 80 is configured to operate a plurality of parts of the vehicle to car-wash-ready states when the processor 80 is activated by the switch 70. For example, processor 80 can cause openings such as the window 24 or the sun roof 50 to close if they are open at the time the switch 70 is activated. The processor 80 can also cause projecting vehicle parts such as the power antenna 62 and/or foldable mirror(s) 40 to retract or fold.

The processor 80 also can temporarily disable a control for operating a vehicle part to prevent operation of the corresponding part during a car wash. For example, the processor 80 switches the radio 60 to an “off” state, thus preventing damage to the antenna 62 in a vehicle in which the antenna 62 is automatically extended when the radio 60 is switched on, and prevents the antenna from extending even if the radio is inadvertently turned on. The processor 80 can also switch the rain sensor 36 to an “off” state, thus preventing automatic activation of the wipers 32, even if moisture is sensed.

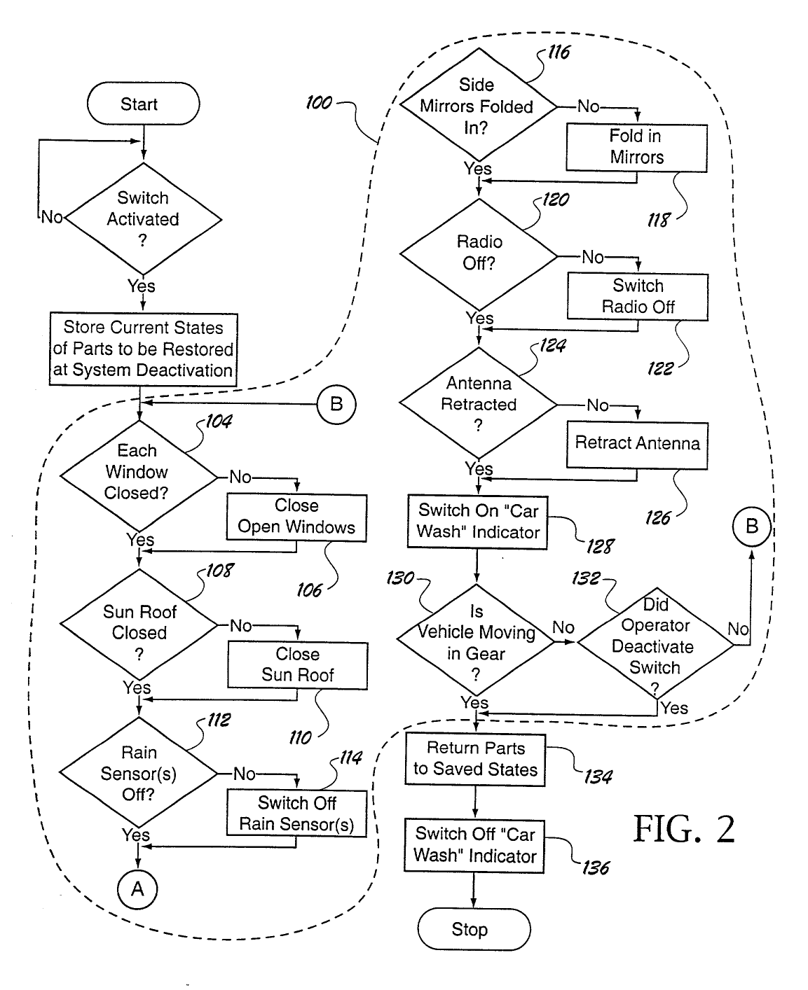

In a second embodiment, the processor 80 is configured to maintain the windows 24, the rain sensor(s) 36, the mirrors 40, the sun roof 50, the radio 60 and the antenna 62 in their car-wash-ready states, thus embodying a method for preparing a vehicle for a car wash as shown in FIG. 2. For example, and as shown in FIG. 2, at 100 the processor 80 maintains vehicle parts 24, 36, 40, 50, 60 and 62 in car-wash-ready states until a completion event is signaled as further described below. The processor 80 is used to determine whether a vehicle part is in a car-wash-ready state and, if not, to change a state of a vehicle part to a car-wash-ready state.

More specifically and referring to FIG. 2, at 104 the processor 80 determines whether each window 24 is closed. This can be done by sensors in the window openings or in the motors 26. If any open windows 24 are detected, at 106 the processor causes the open window(s) 24 to close, for example by operating motor 26. At 108 the processor 80 determines whether the sun roof 50 is closed. This can be done by sensors in the sun roof opening or in the motor 52. If the processor 80 determines that the sun roof 50 is open, at 110 the processor 80 causes the sun roof to close, for example by operating the motor 52. At 112 the processor 80 determines the state of the wipers 32. If the wipers 32 are operating, the processor 80 turns them off, for example by turning off motor 38. The processor 80 preferably also turns off or otherwise deactivates moisture sensor 36, so that the wipers are not automatically activated in the car wash. If a sensor 36 has become activated, at 114 the processor 80 switches off the sensor 36.

At 116 the processor 80 determines whether the side mirrors 40 are folded. This can be done by sensors adjacent the mirror 40 or in the motor 44. If the processor 80 detects any projecting mirror(s) 40, then at 118 the processor causes the projecting mirrors 40 to fold toward the vehicle, for example by operating the motors 44. At 120 the processor 80 checks whether the radio 60 is in the “off” state. If the radio 60 has been switched to the “on” state, at 122 the processor 80 switches the radio 60 to the “off” state. At 124 the processor 80 determines whether the antenna 62 is retracted. If the antenna 62 is extended, then at 124 the processor 80 retracts the antenna 62. In another embodiment in which the antenna 62 is automatically retracted when the radio 60 is switched to the “off” state, the processor 80 does not perform the step shown at 124. When the vehicle parts 24, 36, 40, 50, 60 and 62 have been placed in their car-wash-ready states, at 128 the processor 80 switches a “car-wash ready” indicator (not shown) to an “on” state.

Signaling of a completion event switches the processor 80 out of the car-wash ready mode, i.e. causes the processor 80 to cease maintaining vehicle parts in their car-wash-ready states. For example, the processor 80 ceases maintaining parts in car-wash-ready states upon a determination 130 that the vehicle is moving while in a drive gear, i.e. a transmission (not shown) of the vehicle is in a non-neutral state. A completion event could also be signaled at 132, for example, when the vehicle operator deactivates the switch 70.

In the embodiment shown in FIG. 1, information is transmitted to the processor 80 from which current states of the rain sensor 36 and the radio 60 can be determined. Of course other or additional vehicle parts can be configured such that information as to their current states is made available to the processor 80. For example, and as shown in FIG. 2, the processor 80 performs the steps described at 104, 108, 112, 116, 120 and 124 using current state information for parts 24, 50, 36, 40, 60 and 62 respectively. In another embodiment, the processor assumes that a part is not car-wash-ready and operates the part to its car-wash-ready state.

Where current state information is available to the processor 80, the processor 80 can save this information and utilize the saved information when the processor is switched out of the car-wash-ready mode. For example, and referring to FIG. 2, at 134 the processor 80 returns at least one vehicle part to its state preceding its car-wash-ready state. Thus, for example, where the radio 60 had been switched on before a car wash and was switched off by the system 10 in preparation for the car wash, the processor 80 can automatically switch the radio 60 “on” when the system exits the car-wash-ready mode, for example, when the user operates switch 70 or when the vehicle is put in gear. Additional embodiments are contemplated wherein various combinations of vehicle parts, and various default states for such parts, are programmed into the programmable controller to accommodate individual operator preferences as to system 10 operation. When the processor has completed the steps indicated at 100 and returned any parts to saved states as described at 134, at 136 the “car-wash ready” indicator (not shown) is switched to an “off” state.

The above described system and method allow a vehicle driver conveniently to prepare a vehicle for a car wash, for example, by pressing a single button. Because the above system can automatically maintain the vehicle as car-wash-ready for the duration of the wash, the driver is prevented from e.g. accidentally or inadvertently opening a window or causing an antenna to extend. Furthermore, because the above system is deactivated by driving a vehicle away from a car wash, the driver does not have to remember to deactivate the above system.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. In combination with a vehicle having a plurality of parts operable between at least a first state in which the part is not ready for an automated car wash, and a second state in which the part is ready for an automated car wash, a car-wash ready system comprising at least one processor having a car-wash ready mode in which the processor is configured for operating the parts to their second car-wash-ready states, and a switch for switching the processor into and out of its car-wash ready mode.

2. The combination according to claim 1 wherein the plurality of parts comprise at least one of a motor-driven power window; a motor-driven power sun roof; a motor driven power antenna; a motor-driven foldable side view mirror, and a moisture activated automatic windshield wiper.

3. The combination according to claim 1 wherein the plurality of parts includes at least one motor-driven power window, operable between an open state and a closed, car-wash ready state.

4. The combination according to claim 1 wherein the plurality of parts includes at least one motor-driven power sun roof, operable between an open state and a closed car wash ready state.

5. The combination according to claim 1 wherein the plurality of parts include at least one motor-driven power antenna, operable between an extended state, and a retracted, car-wash ready state.

6. The combination according to claim 1 wherein the plurality of parts includes at least one motor-driven power mirror, operable between an extended state and a retracted, car-wash ready state.

7. The combination according to claim 1 wherein the plurality of parts includes at least one moisture activated automatic windshield wiper, operable between an automatic state in which moisture automatically triggers the windshield wiper, and a car-wash ready state in which moisture does not automatically trigger the windshield wiper.

8. The combination according to claim 1 wherein at least some of plurality of parts include a control for operating the part, and wherein while the processor is in its car-wash ready mode the processor temporarily disables the control to prevent operation of the corresponding part.

9. The combination according to claim 1 wherein the vehicle includes a transmission including at least one drive gear, and wherein the switch switches the processor out of its car-wash ready mode when the vehicle is put in the at least one drive gear.

10. The combination according to claim 1 wherein the processor automatically restores at least some of the plurality of parts to the states the parts were in prior to when the processor was switched to the car-wash ready mode, when the processor is switched from its car-wash ready mode.

11. A method for preparing a vehicle for a car wash, said method comprising the step of maintaining a plurality of vehicle parts in car-wash-ready states until a completion event is signaled, said step performed using a processor.

12. A method in accordance with claim 11 further comprising the step of determining whether a vehicle part is in a car-wash-ready state.

13. A method in accordance with claim 11 further comprising the step of changing a state of a vehicle part to a car-wash-ready state.

14. A method in accordance with claim 13 wherein said step of changing a state of a vehicle part to a car-wash-ready state comprises the step of performing at least one of closing a window, closing a sun roof, switching off a radio, switching off a rain sensor, retracting an antenna, and folding in a mirror.

15. A method in accordance with claim 11 wherein said step of maintaining a plurality of vehicle parts in car-wash-ready states until a completion event is signaled comprises the step of determining whether a vehicle transmission is in a non-neutral state while the vehicle is moving.

16. A method in accordance with claim 12 further comprising the step of returning a vehicle part to a state preceding a car-wash-ready state.

17. A method for preparing a vehicle for a car wash, the vehicle including at least one motor-driven power window, at least one windshield wiper activated by at least one rain sensor, and at least one motor-driven power mirror, said method comprising the steps of:
operating the at least one power window to a closed state;
switching the at least one rain sensor to an off state;
switching the at least one power mirror to a retracted state; and
maintaining the states until a completion event is signaled, said steps performed using a processor.

18. A method in accordance with claim 17 wherein the vehicle includes a power-driven sun roof, said method further comprising the steps of:
switching the sun roof to a closed state; and
maintaining the sun roof in a closed state until the completion event is signaled.

19. A method in accordance with claim 17 wherein the vehicle includes a radio and a power-driven antenna operable by the radio, said method further comprising the steps of:
switching the radio to an off state; and
maintaining the radio in the off state until the completion event is signaled.
